(19) United States
(12) Patent Application Publication
(10) Pub. No.: US 2008/0260886 A1
(43) Pub. Date: Oct. 23, 2008

(54) Clamping Plate With Intergrated Heat Insulation

(76) Inventors: Klaus-Dieter Nies, Kirchhundem (DE); Wolfgang Nies, Attendorn (DE)

Correspondence Address: MATTHIAS SCHOLL, 14781 MEMORIAL DRIVE, SUITE 1319, HOUSTON, TX, 77079, US

(21) Appl. No.: 10/598,507

(22) PCT Filed: Feb. 25, 2005
(86) PCT No.: PCT/DE05/00316

§ 371 Date: Jan. 18, 2008

(30) Foreign Application Priority Data
Mar. 5, 2004 (DE) 20 2004 003 442.5

(51) Int. Cl. B29C 43/32

(52) U.S. Cl. 425/453

(57) ABSTRACT

In standardized mold making the structure of the mold is at present generally formed according to the following principle: A so-called clamping plate (1 to 3), having usually a larger width, is attached at the end of both half-molds and the other mold structure plates (4) are screwed thereto. The area of the clamping plate that projects the most on both sides is then used to connect the half-molds with the molding press. Thermal protection plates are often employed to minimize the heat transfer to the molding press. The thermal protection plates are commonly screwed onto the front surfaces of the clamping plates. This can lead to problems vis-a-vis the overall parallel alignment of the mold structures. The invention arises out of the underlying requirement to provide an optimal thermal protection over the entire equipment lifetime without limitations vis-a-vis the parallel alignment of the mold structures. This requirement is fulfilled in embodiments of the invention in that the clamping plate is provided as a multilayer composite panel having thermally-insulating steel components (2) and tool steel components (1) and (3), while the exterior sides are always made of tool steel.

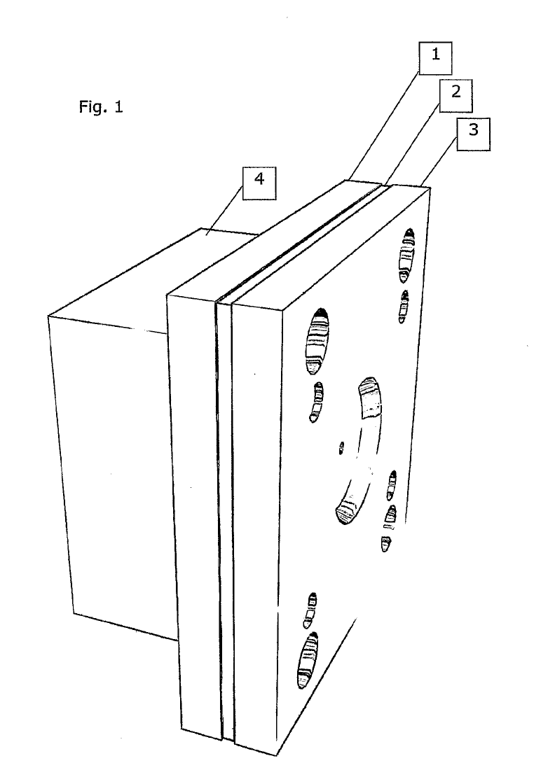

In standardized mold making, the structure of the mold is at present generally formed according to the following principle:

The mold is made of two parts and consists of a feed side and an ejector side. The height and/or the number of mounting plates and mold carrying plates of the respective half-molds is determined by the dimensions of the production part. A so-called clamping plate (1 to 3), having usually a larger width, is attached at the end of both half-molds and the other mold structure plates (4) are screwed thereto. The area of the clamping plate that projects the most on both sides is then used to connect the half-molds with the molding press, e.g., by means of brackets. In addition, thermal protection plates have been employed over the past several years to minimize the heat transfer to the molding press. Thermal protection plates, which are commercially available from resellers or directly from the manufacturers, are screwed onto the front surfaces of the clamping plates.

Thermal protection plates are often damaged during exchange of molds due to the heavy weight and the handling with lifting equipment. As a result and often unnoticed, the exterior surface of the tools becomes uneven, thereby putting the overall parallel alignment of the mold structures at risk. In addition, it often takes much effort to mount the thermal protection plates competently and level-surfaced. Furthermore, the standard material structure and the production technology applicable to mold structure plates make the parallel alignment of high performance mold structures impossible to attain on a commercial scale.

This invention arises out of the underlying need for an optimal thermal protection over the entire equipment lifetime without limitations vis-a-vis the parallel alignment of the mold structures.

This requirement is fulfilled in embodiments of the invention in that the clamping plate is provided as a multilayer composite panel having thermally-insulating steel components (2) and tool steel components (1) and (3), while the exterior sides are always made of tool steel.

1. A clamping plate with integrated thermal insulation, comprising a sandwich-like structure made of heat-insulating thermosetting core (2) and steel tool covers (1 and 3) on exterior surfaces, their joint being manufactured in a special gluing process, wherein in the gluing process combined of gluing and pressing events, the steal covers of the clamping plate are heated, preferably inductively, and used subsequently as a pressing tool for a molding compound, which compound is turned during this process into the heat-insulating core of the clamping plate; and the process, which is related to an SMC process, is distinguished therefrom, particularly in that the resin formulation of the molding compound does not display any separation effects with respect to metal surfaces, but rather enters into an irreversible bond with the steel covers.
